(19) United States
(12) Patent Application Publication
(10) Pub. No.: US 2023/0327859 A1
(43) Pub. Date: Oct. 12, 2023

(54) SYSTEM AND METHOD FOR DISTRIBUTED CUSTODY ACCESS TOKEN MANAGEMENT

(71) Applicant: Coremeleon, Inc., Brookline, MA (US)

(72) Inventor: Andrew Carl Stern, Brighton, MA (US)

(21) Appl. No.: 18/299,535

(22) Filed: Apr. 12, 2023

Related U.S. Application Data
(60) Provisional application No. 63/330,094, filed on Apr. 12, 2022.
(60) Provisional application No. 63/402,160, filed on Aug. 30, 2022.

(51) Int. Cl. H04L 9/08; H04L 9/14

(52) U.S. Cl. CPC H04L 9/0838; H04L 9/14

(57) ABSTRACT

A system and method for distributed custody access token management that can include applying a key aggregation function to create a combinatorial association between a primary key and a plurality of subkeys, wherein the combinatorial association allows for the determination of the primary key from the plurality of subkeys; determining recovery or derived keys based on the set of subkeys, wherein the recovery key is capable of regenerating at least one subkey provided another subkey from the set of subkeys; establishing the set of subkeys at a plurality of control devices; and reconstituting the primary key and performing primary key cryptographic operations based on receipt, from the control devices, of a qualifying combination the set of subkeys and the recovery key.

### CROSS-REFERENCE TO RELATED APPLICATIONS

This application claims the benefit of U.S. Provisional Application No. 63/330,094, filed on 12 Apr. 2022, and U.S. Provisional Application No. 63/402,160, filed on 30 Aug. 2022, both of which are incorporated in their entireties by this reference.

### TECHNICAL FIELD

This invention relates generally to the field of digital access and more specifically to a new and useful system and method for distributed custody or identity access token management.

### BACKGROUND OF THE INVENTION

Digital security is an ever-increasing problem. Passwords are a great source of pain for users and a prime attack vector for bad actors. In the cryptocurrency space, attacks and errors have resulted in huge financial losses for those that can't secure their private keys properly. Not only is the theft of private keys a serious threat, but misplacement of private keys or damage to a device holding private keys can similarly have devastating effects.

Digital security is also a challenge for other user authentication solutions. Current password solutions present several problems that compromise both user experience and security. Firstly, the need for complex and unique passwords across multiple platforms often leads to users forgetting their passwords or resorting to repeated use of the same password, which makes them vulnerable to attacks. Secondly, password storage and retrieval mechanisms, such as password managers or physical notes, can be susceptible to hacking or loss, further increasing security risks. Additionally, the traditional password-reset process relies on security questions, which are often easily guessable or discoverable by attackers, or on email-based resets, which can be compromised if the associated email account is breached. Lastly, password-based systems are prone to phishing and brute-force attacks, where malicious actors attempt to gain unauthorized access by guessing or stealing passwords. These issues highlight the need for more robust and user-friendly alternatives to password-based security solutions.

Thus, there is a need in the digital access field to create a new and useful system and method for distributed custody access token management. This invention provides such a new and useful system and method.

### BRIEF DESCRIPTION OF DRAWINGS

FIG. 1 is a schematic representation of an exemplary implementation of the system and method.

FIG. 2 is a schematic representation of a variation of a system.

FIGS. 3 and 4 are diagram representations of exemplary variations.

FIG. 5 is a schematic representation of a scenario where a user uses the system and method for accessing a work account and accessing a personal account.

FIG. 6 is a flowchart representation of a method variation.

FIG. 7 is a flowchart representation of a method variation where subkeys are distributed.

FIG. 8 is a flowchart representation of a method variation with a recovery key.

FIG. 9 is a schematic representation of use of a user subkeys and a derived key.

FIG. 10 is a flowchart representation of a method variation used for resolving a subkey issue.

FIG. 11 is a flowchart representation of recovering a subkey.

FIG. 12 is a flowchart representation of refreshing key fragments if an initial subkey is compromised.

FIG. 13 is a schematic representation of losing and then recovering a subkey.

FIG. 14 is a schematic representation of resolving a subkey-issue where an attacker compromises a subkey.

FIG. 15 is a schematic representation of subkeys being distributed across storage systems of multiple entities.

FIG. 16 is a schematic representation of a user using duplicates of one subkey.

FIGS. 17A and 17B are schematic representation of a non-user entity managing a one or a plurality of the key fragments.

FIG. 18 is a schematic representation of using n subkeys and m derived subkeys.

FIG. 20-28 are diagrams of exemplary implementations and variations for different secured compute operations.

FIG. 29 is a schematic representation of an exemplary recovery implementation.

FIG. 30 is a schematic representation of variations for redundant storage of a subkey.

FIG. 31 is a schematic representation of various control devices coordinating with a recovery service.

FIG. 32 is an exemplary system architecture that may be used in implementing the system and/or method.

### DETAILED DESCRIPTION OF THE EMBODIMENTS

The following description of the embodiments of the invention is not intended to limit the invention to these embodiments but rather to enable a person skilled in the art to make and use this invention.

1. Overview

A system and method for a distributed custody access token management functions to enable a token-based digital authentication solution that relies on a set of subkeys used in forming a real key (i.e., private key) that may or may not also be used in combination with a recovery key and/or derived key. The system and method enable hybrid custody key technology that can reduce risk and increase usability.

The system and method may enable secure cryptographic operations and components to operate on zero trust hardware and software stacks.

The system and method leverage a combinatorial association between a private key and a plurality of subkeys, enabling the determination or reconstitution of the private key from the subkeys. This approach enhances security and usability in various digital authentication scenarios, such as secure data storage, multi-user access control systems, and hardware-based key management.

Additionally, in some variations the system and method may introduce a recovery key, which can be used to regenerate at least one subkey when combined with another subkey from the set of subkeys. This feature provides a mechanism for recovering lost or inaccessible subkeys, as well as refreshing the entire set of subkeys when necessary. The recovery key can be stored securely within a blockchain network, accessible within a recovery system of a computing platform, or managed in other ways.

The system and method may involve instantiating, distributing, or otherwise establishing a set of subkeys at a plurality of control devices, which may include user devices (client devices or applications which may be associated with a user account), blockchain networks, or managed computing platforms of trusted entities. This distribution of control adds an additional layer of security by separating the subkeys and requiring a qualifying combination of subkeys and optionally the recovery key to perform private key cryptographic operations.

The system and method may provide a flexible and secure solution for managing cryptographic keys in a distributed environment, enabling enhanced protection and usability in digital authentication processes.

The system and method preferably implement a token generation and management process that can generate subkeys, generate primary keys from subkeys, and optionally recover subkeys through a recovery key when given a subset of the subkeys. Furthermore, the token management processes may additionally include cycling of subkeys and recovery keys.

The system and method may enable a new cryptographically secure way of managing digital keys that may enable distributed sharing of key components across devices and/or parties.

In one use model, the system and method may enable different fragments of a key (i.e., subkeys) to be distributed across devices and/or parties and then the key fragments may be aggregated in some manner to form an end use key (e.g., a user's primary key such as a private key).

In another use model, a user may retain and use an end use key (e.g., a user's private key), but to ensure recoverability of that key, sub-component versions of the key may be established at different devices and/or with different parties. This may be done so that loss or corruption of the end use key can be recovered by aggregating a combination of the key fragments. In one implementation, a user wishing to enable recoverable of a valuable primary key may have multiple friends or trusted parties enroll to be holders of subkeys for the primary key. A device of the user or some other system on behalf of the primary user may consolidate the subkeys and then combine them with the user's primary key to determine a derived key. Then if the user misplaces their primary key, the various subkeys can be again collected and used in determining the primary key. The key fragments may be secured, controlled, or managed in some way that they would be resilient to attach across all the fragments.

The system and method may have various applications in the digital security space.

The system and method may be used in creating and implementing a new secure digital wallet. Digital wallets may be used to manage cryptocurrencies, digital assets, and other forms of virtual currency. In particular, the system and method may be used in connection with a cryptocurrency- or blockchain-based digital wallet used to manage primary keys (e.g., blockchain private keys). Such digital wallets could include hardware-based wallets or application-based digital wallets. As digital wallets require secure management of private keys to authorize transactions and access stored assets, the distributed custody access token management system and method offer significant improvements in terms of security, usability, and recovery. With the distributed nature of the system and method's subkeys, multiple devices and digital services may operate in cooperation providing access and use of a user's primary keys.

By utilizing the combinatorial association between a private key and a plurality of subkeys, provided via the system and method, digital wallet users may be able to maintain a higher level of security, as the private key can only be determined or reconstituted from the combination of subkeys. This approach reduces the risk of unauthorized access to digital wallets, protecting users' valuable assets.

Moreover, the system and method's recovery key functionality can provide digital wallet users with a robust mechanism to recover lost or inaccessible subkeys, ensuring that wallet access and asset control are not compromised due to lost keys. This feature is particularly beneficial for digital wallet users, as losing access to private keys often results in irreversible loss of assets.

Additionally, the distributed nature of the subkeys can be leveraged in multi-signature digital wallets, where multiple parties are required to authorize transactions. The subkeys can be established or distributed among the parties, with each party holding a subset of the subkeys. This ensures that transactions are only authorized when a qualifying combination of subkeys is provided by the participating parties, enhancing the security and collaborative decision-making process in digital wallet management.

The system and method may offer a versatile and secure solution for digital wallet key management, enabling users to protect their digital assets and maintain control over their cryptographic keys in a distributed and user-friendly manner.

As another exemplary application, the system and method may also be applied as an innovative alternative to traditional username/password credentials for digital authentication. The system and method address some of the many challenges in today's digital landscape that suffers from password reuse, vulnerability to phishing attacks, and susceptibility to brute-force attacks. By utilizing the distributed custody of the subkeys, a more secure and user-friendly approach to digital authentication is possible.

To further increase the difficulty of phishing attacks against authentication credentials, recovery of a user primary key will not be possible simply by identifying themselves with something they know (e.g., a username and password), something they are (e.g., biometrics), or something they own (e.g., a smartphone or hardware security device like a YubiKey or HSM). Instead, the user (and therefore any attacker trying to pose as a legitimate user) may first identify themselves with one or multiple traditional identification methods, but also request access from the other users or devices that are required to reconstruct the primary key. Since primary keys may only be determined or reconstituted from the combination of subkeys and/or derived or recovery keys, the risk of unauthorized access is reduced.

The recovery key functionality of the invention may further enhance the security of digital passcodes. In the event that a user loses or misplaces a subkey, the recovery key can be used in combination with another subkey to regenerate the missing subkey, ensuring uninterrupted access to resources and systems. If a subkey is compromised, such as a result of an attacker gaining access to a device or an account, then the recovery key may be used to refresh the other subkeys thereby mitigating the risk from the compromised subkey.

The system and method may additionally or alternatively be used as an access control mechanism or in a variety of other uses.

The system and method may further enable providing a key recovery service that may be used in recovering keys or subkeys without exposing risk to holders of the keys or subkeys.

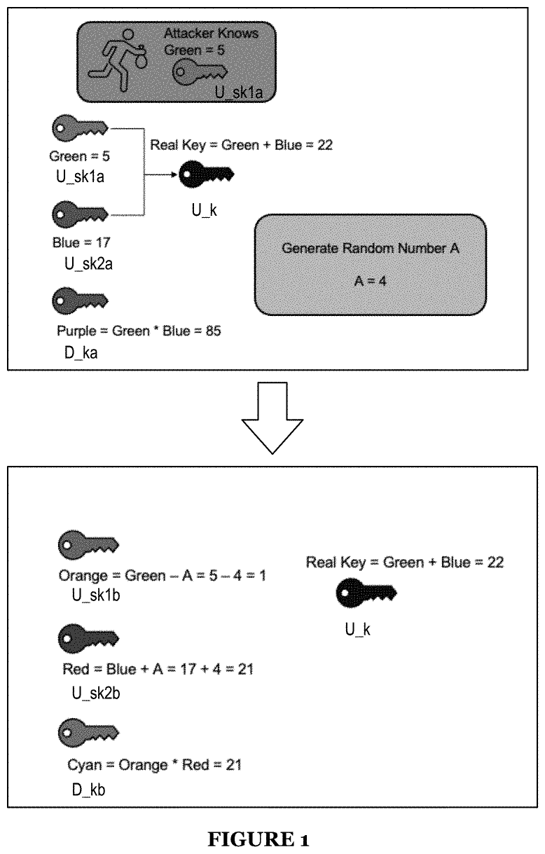

As shown in FIG. 1, in an example of the system and method may be implemented where a primary key can be generated or reconstituted from multiple subkeys. The subkeys green and blue can be combined (using addition in this example) to form the real key (i.e., the private key). These subkeys may be stored or held in different locations and formats and/or by different entities/systems. A purple recovery key is shown that can be used in regenerating a subkey when presented with one of the subkeys. However, the recovery key cannot be used on its own to generate one or both subkeys. Furthermore, FIG. 1 shows how the subkeys can be modified, shown here by adding or subtracting a random number. This cycling of subkeys can render access to old subkeys useless. In this example, an attacker who learns of the green key can do nothing with this information if a user deletes the blue key after cycling the subkeys to form the orange and red keys. These new subkeys can similarly be reproduced with an updated recovery key (e.g., the cyan key).

Variations of the system and method may enable multiple subkeys to be used (e.g., greater than 2 or 3). In this way, the number of required parties or fallback holders of subkeys can be adjusted to fit a particular use case. In one example, this could be used so that if a user loses their subkey, a trusted holder of another subkey can assist in recovering the subkeys. In another example, this may also be used so that all holders of the subkeys are required to access a primary key.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As one potential benefit, the system and method can enable a distributable key subsystem where different and potentially multiple copies of subkeys can be distributed in various ways. This can be used for hybrid custody of key components across devices and/or services of one or more parties.

As another potential benefit, the system and method may be resilient to key loss. For example, a user can be less likely to lose access to their private key (and thereby for example, their cryptocurrency) by being able to distribute their subkeys more freely and by having the backup option of recovery key processing assuming the user has possession of a subset of the subkeys. Any individual subkey is preferably unusable by itself and thereby poses little risk if a subkey is stolen or lost.

As another potential benefit, the system and method can provide reduced risk while enhancing ease of use. Previously, extreme lengths would be used to protect a private key at the sacrifice of usability. The system and method make it harder to steal a private key while including multiple conveniences for using and managing the keys.

As another potential benefit, the system and method can enable refreshing of subkeys despite a loss or theft of a subkey. This can mean a user may not be required to change their account when a subkey is compromised. Security risk may be reset by refreshing the subkeys, thereby rendering the compromised subkey unusable.

2. System

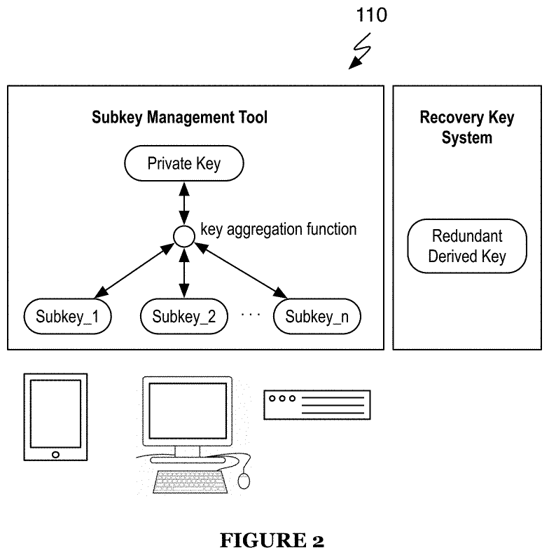

As shown in FIG. 2, a first system for distributed custody token management can include a subkey management tool no which may be a digital service or tool used to generate subkeys, cycle subkeys, perform encryption and computations on subkeys, generate primary keys from supplied subkeys, and compute non-recoverable values associated with primary keys that can be distributed and used by the key owners. As described herein, various approaches may be used in the generation and management of the keys for different scenarios. The system can additionally include a recovery key system.

The system may be implemented and facilitated as a centralized system. The system may alternatively be decomposed into multiple coordinated subsystems. For example, one digital subsystem may facilitate the generation of subkeys while another subsystem may manage the recovery key capabilities.

In general, the system may be one that includes one or more computer-readable mediums (e.g., non-transitory computer-readable mediums) storing instructions that, when executed by the one or more computer processors, cause a computing platform to perform operations comprising a combination of the processes of the method described herein.

The subkey management tool no functions to manage creation and use of subkeys. In one variation, the subkey management tool can manage a primary key (e.g., a user key U_k) and a recovery key (e.g., a derived Key D_k).

The primary key can function as the primary access mechanism to an authentication system. The primary key may be referred to as a user key as it generally serves as the key that is being protected and used in cryptographic operations for a user, but it could be any type of sensitive key or token. The primary key could be some private key or any type of token or key that is sensitive—it is generally the primary piece of data the system is used to protect. For example, the primary key could be the private key used to grant cryptocurrency user ownership and access to funds on a given address in a blockchain.

The primary key is preferably able to be reconstituted or determined from subkeys (e.g., U_sk1, U_sk2, . . . U_skn). In this way, U_k=f(U_sk1, U_sk2, . . . , U_skn), where there are n user subkeys and f is a function (alternatively referred to as a user subkey operator or a “key aggregation function”) used in combining user subkeys into the primary key. The key aggregation function may be an operator or process pre-determined or directly configured. The key aggregation function may alternatively be dynamically selected.

The key aggregation function could be an operator or function configured to perform one or more operations across the subkeys such as an adding operator, subtracting, multiplying, dividing, bitwise operator (XOR, XNOR, OR, NOR, AND, NAND, and the like), and/or other operations. The operator could additionally include a combination of processes.

The recovery key (alternatively referred to as a derived key) functions as a digital record of parity information that can be used to recover all or parts of the primary key. The recovery key may be maintained as a single key but may additionally be decomposed into recovery subkeys. The recovery key may be determined by g_1(U_sk1, U_sk2, . . . , U_skn). If the recovery key is decomposed into m derived subkeys then the recovery key may be determined by g_2(D_sk1, D_sk2, . . . , D_skm). In this way: D_k=g_1(U_sk1, U_sk2, . . . , U_skn)=g_2(D_sk1, D_sk2, . . . , D_skm).

As with the key aggregation function, the g_1 and/or g_2 functions may be pre-determined or otherwise determined. Herein, g_1 may be referred to as a derived key aggregation function (or a “derived user subkey operator”), and g_2 may be referred to as a derived subkey aggregation function (or “derived subkey operator”).

As an optional variation, the subkey management tool may additionally determine a partner key (P_k). The partner key may function so that an individual, organization, and/or system can control authorization of a user. For example, an employer system, government system, financial institution system, and/or the system of another entity) may manage the partner key so that it can control authorization of the user.

The partner key be determined by h_1(U_sk1, U_sk2, . . . , U_skn). If the partner key is decomposed into q partner subkeys then the recovery key may be determined by h_2(P_sk1, P_sk2, . . . , P_skq). In this way:

P_k=h_1(U_sk1,U_sk2, . . . ,U_skn)=h_2(P_sk1,P_sk2, . . . ,P_skq)

Similar to above, the h_1 and/or h_2 functions may be pre-determined or otherwise determined. Herein, h_1 may be referred to as the partner key aggregation function (or “partner user subkey operator”), and h_2 may be referred to as the partner subkey aggregation function (or “partner subkey operator”).

The partner key can be optional in many variations. The partner key may be useful for use cases involving managed systems that may benefit from centralized control. In one example, a user (e.g., a worker) can have an account with some party/entity (e.g., company A). The party can hold P_sk1 and the user's phone can store U_sk1. Another third party may store recovery subkey D_sk1. Using the partner key (or subkey), the partner can have the ability to change the subkeys and revoke the user's access to the partner's system without U_sk1 being a risk.

In one example, the key aggregation function (f) is an addition operator, the derived key aggregation function (g_1) is an XOR bitwise operator, and the partner key aggregation function (h_1) is an AND bitwise operator. Accordingly, in an example of there being two user subkeys:

U_k=5+7=12

D_k=5(XOR)7=2

P_k=5(AND)7=5

In another example, the key aggregation function (f) is a bitwise operator, the derived key aggregation function (g_1) is an XOR bitwise operator, and the partner key aggregation function (h_1) is an AND bitwise operator. Accordingly, in an example of there being two user subkeys:

U_k=5+7=12

D_k=5(XOR)7=2(0101XOR0111=0010)

P_k=5(AND7)=5(0101AND 0111=0101)

One or more user subkeys can be selected and/or randomly generated. Randomly generated user subkeys may be generated using a pseudorandom (PRNG) or true-random number generator (TRNG). In other variations, a hash (e.g., SHA-3) of an input vector or string of characters determined by a key or subkey may be another alternative. Other subkey selection processes may alternatively be used.

Additionally, the keys or subkeys may, in some instances, not be random numbers. A key or subkey may come in other forms such as user defined numbers, numbers that can be generated from things that the user can securely store or remember (e.g., 12-to-24-word seed phrase), or any other method to create a key-like number (independent of length or format or storage mechanism).

In some variations, one subkey may be formatted into a more human-readable (e.g., easier to remember) format, while another subkey may be randomly generated.

Subkeys may be secured using data security mechanisms such as storing in secure hardware systems or restricting access or use by various configured processes such as biometric access authorization.

User subkeys may be stored in a safe location on a device or network of devices (e.g., a “secure enclave). The user subkey, in some instances, may be stored in plaintext or encrypted format in main memory (e.g., a hard drive, solid-state storage, and/or any non-volatile memory), in system memory (e.g., random access memory (RAM)), in a cache structure on the integrated circuit, and/or in any suitable storage solution. For system memory and/or cache or other volatile storage device, the key or subkey may be lost if the system is shut down or loses power. An automatic subkey recovery process may be used when such subkey loss occurs resulting from device restart. Such storage mechanisms may be on a hardware device directly (e.g., physically) accessible to a user, but may additionally or alternatively be stored on network accessible computer readable mediums (e.g., cloud storage). Derived and partner key or subkeys can similarly be stored and managed.

Access to a subkey may be restricted using biometrics passwords, pins, hardware IDs, zero knowledge proofs, multi-factor authentication, and/or other authentication/authorization mechanisms. Such access security mechanisms may be used individually or in combination for one or more subkeys.

The system may be implemented such that the user subkeys can be used independent of a derived key or partner key. In this way, a user can use a set of subkeys managed on one or more devices and can authenticate a user account without another account.

In some variations, there may be benefits for having an additional outside party involved. An external 3rd party could host and manage the derived key, for example.

In an example of a blockchain crypto wallet application, a user may manage user subkeys with two devices and a derived key using a 3rd party (e.g., to assist in subkey recovery or refreshing).

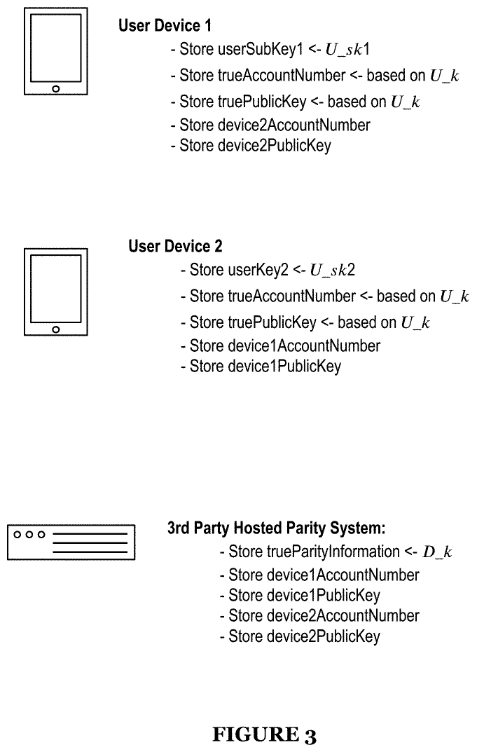

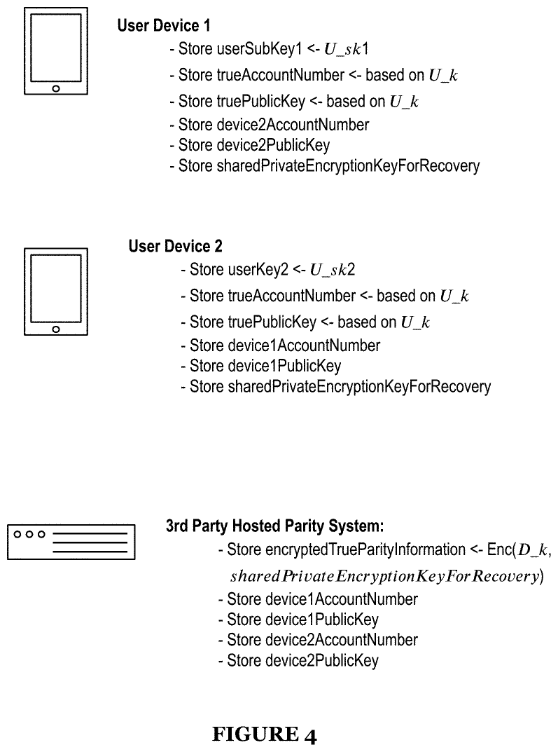

As shown in FIG. 3, parity information may be unencrypted. Alternatively, as shown in FIG. 4, parity information may be encrypted and stored for enhancing security. For example, parity information may be encrypted using an encryption process such as Enc(D_k, subkey_aggregation).

In some variations, the parity information may be stored in a distributed fashion for storage resilience. For example, various networked devices (e.g., Tor) or a blockchain-based solution could be used for distributing storage of the parity information. In this example, an online or offline user device 1 and device 2 may hold the relevant information, and a parity storage system may be a network of device or blockchain-based storage medium to store the derived key or subkeys.

In some variations, a device storing a subkey or key can be an offline device. In some variations, the system may not include or depend on a network store or compute of information. A subkey could be stored in an offline device that can have capabilities to either be human readable or securely transmit data to a device or device that can reach a network. An offline device could be, for example, a hardware wallet, a near field communication device (e.g., NFC-enabled credit card), hardware security module capable of encrypting or decrypting a key or subkey (e.g., YubiKey), or other suitable type of device. In one example, a smartcard with NFC can securely store and transmit data to a smartphone that can relay the data to a cloud provider.

Each entity or device holding each key or subkey may, optionally, hold multiple keys or subkeys to authenticate other users or accounts (with the same or different users). In this way a network of devices or systems can be used for management of multiple primary keys.

Additionally, a user with multiple devices can select a subset of a larger group of devices to manage each account. This may be used in some scenarios when not all devices are desired to have access or be subject to authentication across different use cases and platforms.

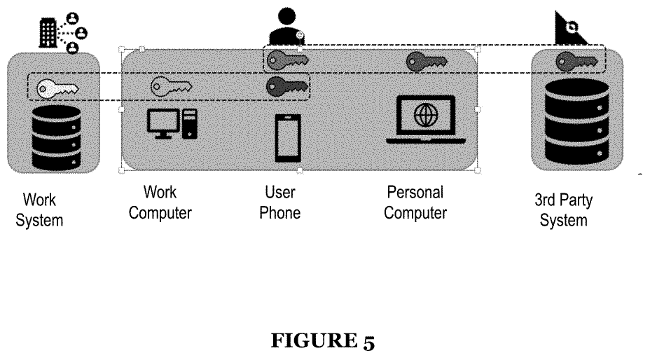

As shown in FIG. 5, a work and home account management solution may have a user with a work computer, a phone, and a personal computer. The phone may contain multiple user subkeys: one personal user subkey and one work-related user subkey. As shown in FIG. 5, different groupings of subkeys can have different configurations. In one configuration, the user has one subkey on a phone, one subkey on a personal computer, and recovery key managed in a third-party system. In another configuration, the user has one subkey on the phone, one subkey on a work computer, and a recovery or partner key in a work system.

As mentioned, the system may additionally include a recovery key system, which functions to enhance recoverability of subkeys.

In one variation, redundant storage of subkeys can be used, which can increase recoverability of keys.

To add redundancy in some variations, keys may be split into groups. With subkey groups, one subkey can be lost per user group. With redundant subkey groups a set of operators and subkeys can be setup according to:

U_k=f(f_r1(U_sk1,U_sk2, . . . ,U_sknr1),f_r2(U_(sk(nr1+1)),U_(sk(nr1+2)), . . . ,U_sknr2), . . . ,f_rr(U_(sk(nr(r−1)+1)),U_(sk(nr(r−1)+2)), . . . ,U_sknrr))

D_k=g_1(g_r1(U_sk1,U_sk2, . . . ,U_sknr1),g_r2(U_(sk(nr1+1)),U_(sk(nr1+2)), . . . ,U_sknr2), . . . ,g_rr(U_(sk(nr(r−1)+1)),U_(sk(nr(r−1)+2)), . . . ,U_sknrr))=g_2(D_sk1,D_sk2, . . . ,D_skm)

Here, ‘r’ can be used to represent the number of keys that can be recovered.

Alternatively, the initial subkey may be modified with redundant data striped across each derivative subkey to perform recovery. In this striped variation, r subkeys can be lost across all user subkeys. This may be implemented using a RAID or redundantly distributed manner, with a redundant array of inexpensive disks, (0, 1, 5, 6, 10, etc.) technologies, or this can be implemented using a back-up type strategy or other suitable system.

3. Method

A method for distributed custody token management can include various processes that facilitate establishing a combinatorial association between a primary key and multiple subkeys that can recombine to form the primary key, whereby the distribution and management of the subkeys may mitigate risks while preserving usability for a user. For example, the method may enable processes by which a user can recover from individual digital attacks or property loss either by regenerating a lost subkey or updating all subkeys without altering the state of the primary key. This method can be used to implement various digital user subkey applications, which, as described herein, may be implemented using various computer architectures depending on the use case.

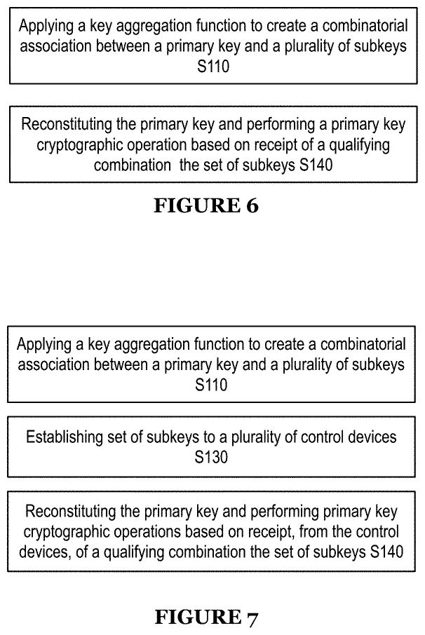

As shown in FIG. 6, a method for distributed custody token management may include applying a key aggregation function to create a combinatorial association between a primary key and a plurality of subkeys Silo; and reconstituting the primary key and performing a primary key cryptographic operation based on receipt of a qualifying combination of the set of subkeys S140.

The combinatorial association allows for the determination of the primary key from the plurality of subkeys. With a combinatorial association the aggregation function establishes a relationship such that the subkeys are usable in aggregate to form or generate the primary key. With the combinatorial association, the set of subkeys can be combined to generate the primary key. In some implementations, the primary key may be deleted and only maintained during its use (e.g., not stored in permanent storage). In some variations, the primary key may be held and used by a primary user, while the subkeys can serve as a backup to reconstitute the primary key if it is lost. Furthermore, any one subkey cannot be used alone to deterministically define the primary key (e.g., no one subkey is the same as the primary key).

In some variations, subkeys may be initially determined, generated, selected (based on user input) or otherwise established. Then the primary key may be generated or determined from the set of subkeys. In other words, block S110, may include or be implemented by determining the primary key based on a set of subkeys. In one variation, the primary key may be a derived key that is the result of an aggregation function that performs some aggregation operation on the set of subkeys and a pre-defined input key (e.g., a private key the user wishes to be able to recover). In some variations, a primary key may be initially generated or determined (possibly from outside system) and from this primary key the subkeys are determined. In other words, block S110, may include or be implemented by determining a set of subkeys based on a primary key.

The method is often used for establishing a relationship between a primary key to different related keys that must be used in combination to reproduce the primary key. This can be used so that any individual key storage of the subkey is not a risk for direct access to a primary key. Multiple related keys would need to be compromised in order for a primary key to be at risk. Accordingly, the method can utilize distribution of subkeys to various control devices (e.g., computing platform systems, client devices, hardware devices, digital networks like blockchains). Additionally, in many variations, the method can be used to reconstruct the primary key and using it one or more cryptographic operations.

Accordingly, a method used for device distribution and applications for cryptographic operations may include, as shown in FIG. 7, applying a key aggregation function to create a combinatorial association between a primary key and a plurality of subkeys Silo, wherein the combinatorial association allows for the determination of the primary key from the plurality of subkeys; establishing the set of subkeys to a plurality of control devices S130; and reconstituting the primary key and performing primary key cryptographic operations based on receipt, from the control devices, of a qualifying combination the set of subkeys S140.

The method can be used in various ways and in different situations.

The reassembled primary key of block S140 can be used in a digital authentication process within a digital system, wherein the primary key serves as a cryptographic credential such as part of a private/public key pair. This may be a user account authentication process such as for a user logging into a digital account with some entity operating a digital platform that uses digital authentication. The digital authentication process may also be part of other forms authentication. For example, primary keys used as part of application programming interface (API) credentials could similarly be generated and loaded into the memory of a machine by receiving a qualifying combination of subkeys.

In one variation, the method may be used within a secure data storage and retrieval system. The primary key may be used to encrypt and decrypt sensitive data. The primary key may be used (either during initial generation of the primary key or in response to subkeys used to reassemble the primary key for ephemeral/temporary use) to encrypt and/or decrypt sensitive data. In one example, this may enable enforcing participation from multiple parties for decryption of data, if the subkeys are distributed across multiple parties. In another example, users can more comfortably store data with strong encryption with less risk that the loss of a single credential (e.g., a primary key) could result in losing access to the data. As described herein various process may enable recovery of subkeys using a recovery/derived key.

In another variation, the method may be used and applied for enforcing distributed access control within a multi-user digital computing environment. Users may be assigned one or more subkeys. Various actions or resources or other policies may depend on multiple users supplying subkeys to reconstruct a primary key. This may increase security and ensure collaborative decision making through the operation of the digital system.

In another variation, the method may be used within or with integration with a hardware security module or secure enclave. In one such variation, a secure enclave could be designed such that it may internally reconstitute a primary key within its secure computing environment based on supply of a combination of subkeys (e.g., one or more externally supplied subkey and possibly one internally stored subkey). The primary key may be used for some operation but never persistently stored beyond some usage window.

In another variation, the method used within or with integration with a hardware security module or secure enclave may be used to store encrypted versions of the private key, subkeys, derived keys, or recovery keys. In one such variation, the individual keys and fragments would not be exposed to devices with antennas or radios which may increase relative risk of attack. Alternatively near-field communication (NFC, ultra-wideband, or similar technologies) may be used with the security module or secure enclave to communicate to relevant devices to balance risk with usability.

In another variation, the method may be used in connection with a cryptocurrency, blockchain, or other type of distributed ledger wallet. A digital wallet may store one subkey and/or receive input of one or more subkeys as a way of temporarily determining or permanently reconstructing the primary key for performing some cryptocurrency/blockchain transaction.

In some applications, such as regulated financial transactions (cryptocurrencies, stocks, or otherwise), access controls dictate the sending of assets and the parameters by which you need secondary or tertiary signatures prior to the disbursement of funds. By utilizing subkey aggregation on an individual basis, the systems by which you authenticate an individual signer can be linked to the cryptographically provable signature to validate the transfer of funds.

In another variation, the method may be used in enabling differing authentication processes. The method may be used as part of or as an alternative to passcode authentication. This may occur when a user is requested to validate their identity by use of traditional identification techniques (e.g., passwords, two factor authentication codes, email address, phone number, government ID), but will not truly gain access to a private key (and therefore the desired system) until they can prove their identity by means of social proof to other devices, users, or entities and request access to their related subkeys.

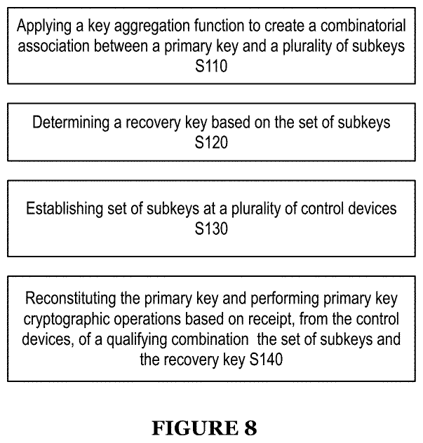

In some variations, the method can enable the use of a recovery key (i.e., a derived key), which may be used to recover a missing subkey and/or refreshing all subkeys. Such actions may be taken without altering the primary key. Accordingly, a method using a recovery key may include, as shown in FIG. 8: applying a key aggregation function to create a combinatorial association between a primary key and a plurality of subkeys S110, wherein the combinatorial association allows for the determination of the primary key from the plurality of subkeys; determining a recovery key based on the set of subkeys S120, wherein the recovery key is capable of regenerating at least one subkey provided another subkey from the set of subkeys; establishing the set of subkeys at a plurality of control devices S130; and reconstituting the primary key and performing primary key cryptographic operations based on receipt, from the control devices, of a qualifying combination the set of subkeys and the recovery key S140. In some variations, a first user wishing to make a specific end user key recoverable may invoke a method variation where the end user key of the first user can serve as the first user's subkey. For example, other trusted parties may have their own subkeys established on one or more of their control devices. These subkeys can be used with the first users end user key to determine a derived/recovery key using an aggregation function. In this exemplary use case, the user may typically use their end user key in a typical fashion. However, if they lose access to their end user key, then the other subkeys can be supplied and used with the derived/recovery key to redetermine the end user key (e.g., like a lost subkey).

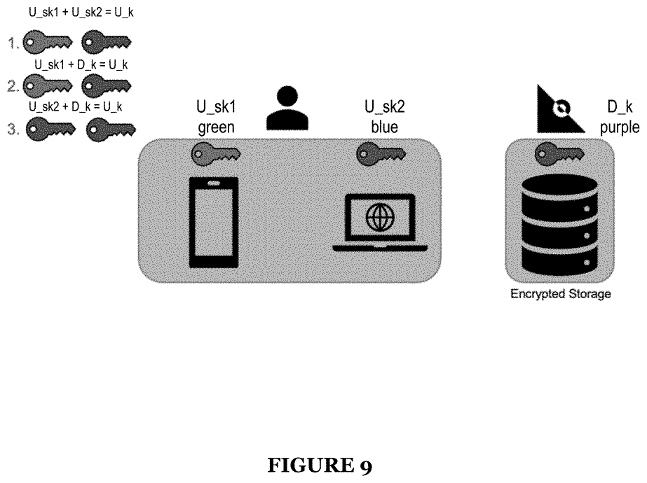

As shown in FIG. 9, the method may be implemented so as to establish the combinatorial association between a user key (e.g., a primary key) and two subkeys (U_sk1 and U_sk2) and also establish a derived key (D_k) (alternatively referred to as a recovery key). The decomposing of the user key can be used such that a single user's wallet has no centralized point of attack by fragmenting the primary key. As shown in FIG. 9, the user subkeys could be stored on two different personal computing devices, and a derived key may be stored in managed cloud system.

In this example of FIG. 9, to use a user's digital wallet, may depend on having 2/3 (or N/M where M>N) key fragments to be presented. This may be the two user subkeys but could also include one user subkey with the derived key.

As shown in FIG. 3, one implementation of the method may involve multiple control devices storing various data records such that a system could manage coordinated use of these subkeys and/or recovery keys. This example describes two user devices (user device 1 and user device 2), and a managed computing platform used to store a recovery key (e.g., parity information usable for recovery).

In this implementation, a user device 1 may store: a userSubKey1 (U_sk1), a trueAccountNumber (based on U_k), a truePublicKey (based on U_k), a device2AccountNumber, and device2PublicKey.

Also in this implementation, a user device 2 may store: a userSubKey2 (U_sk2), a trueAccountNumber (based on U_k), a truePublicKey (based on U_k), a device1AccountNumber, and a device1PublicKey.

Also in this implementation, the managed computing platform may store: trueParityInformation (D_k—a recovery key), a device1AccountNumber, a device1PublicKey, a device2AccountNumber, and a device2PublicKey. The recovery key could be stored as an encrypted parity information (e.g., Enc(D_k, subkey_aggregation)) or as unencrypted parity information.

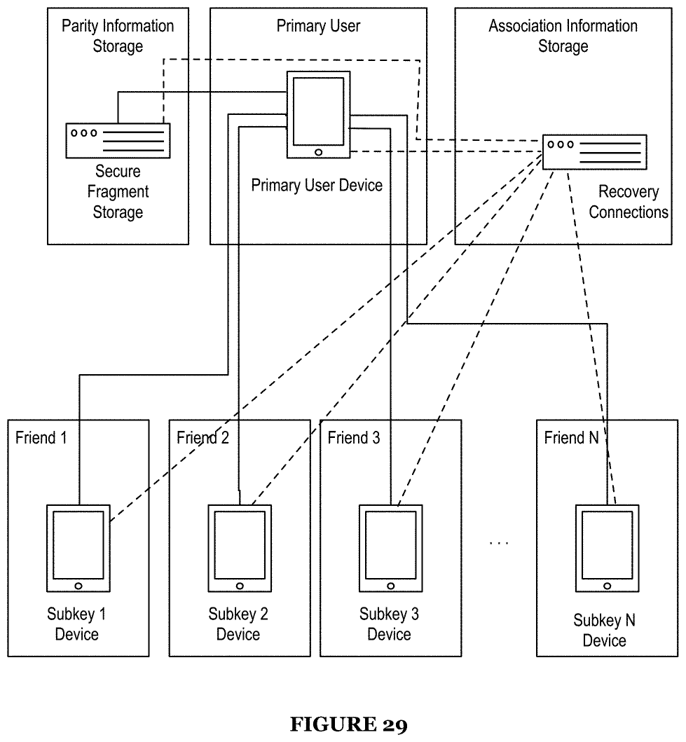

In this exemplary variation, the various data associates stored at the different devices may be used to ensure connections may be made or repaired after a connection is first mate. For example, user device 1 will hold information of the other related user account that may hold the other subkey. These data association records may be stored on a device. Alternatively, in another variation, a managing computing system may store information so that it can coordinate how subkeys and other keys (primary keys/recovery keys) may be coordinated. As shown in FIG. 29.

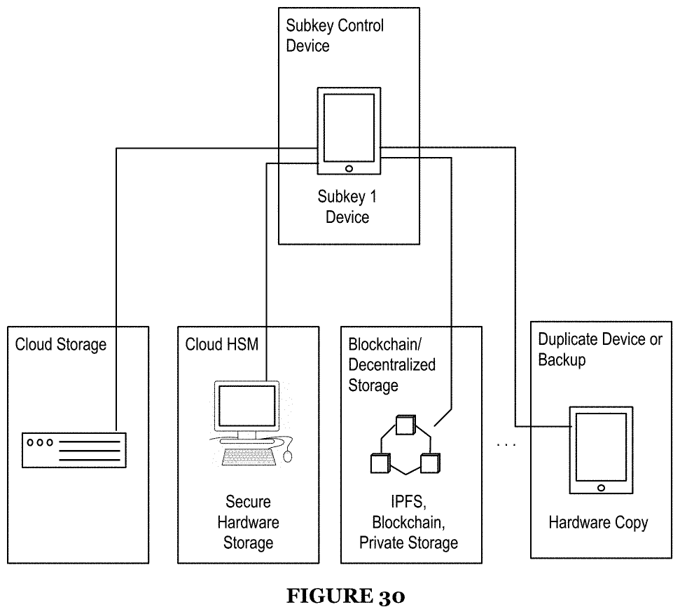

Additionally, while the subkeys are discussed primarily as being stored or managed at one control device, a subkey may be backed by multiple devices or computing infrastructure to store and/or backup a subkey. A subkey in many instances does not individually compromise sensitive data and so it may be stored in some cases in more flexible ways. As shown in FIG. 30, a subkey may be backed up to one or more different types of computing systems such as a cloud storage solution, a secure hardware storage, a blockchain or decentralized storage system, and/or some other backup storage solution.

The method may additionally include processes for recovery or resolving issues with one or more subkey. These processes may be used to recover missing or inaccessible subkeys. These processes may additionally or alternatively be used to refresh the subkeys which can mitigate risk if one of the subkeys may have been compromised.

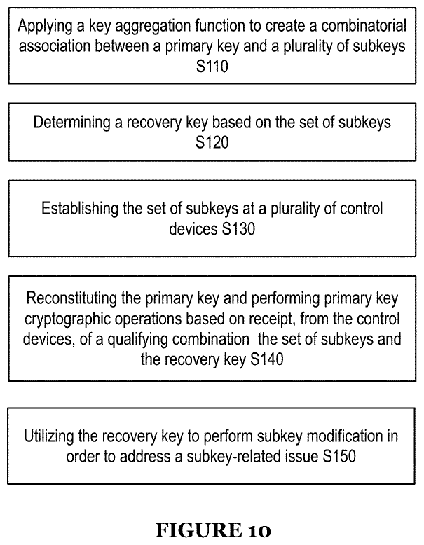

Accordingly, the method may include, as shown in FIG. 10, utilizing the recovery key to perform subkey modification in order to address a subkey-related issue S150. As discussed, the recovery key is associated with a plurality of subkeys. The recovery key may store parity information and/or other derived data related to the plurality of subkeys such that it can be used to regenerate a subkey when supplied other subkeys and/or refresh all subkeys while preserving the capability of reconstituting the primary key.

In some variations, the subkey-related issue indicates that a subkey should be regenerated. This may occur if the subkey-related issue involves an inaccessible subkey (malfunction or issue with a hardware storage of a subkey) or a lost subkey (not able to locate a subkey).

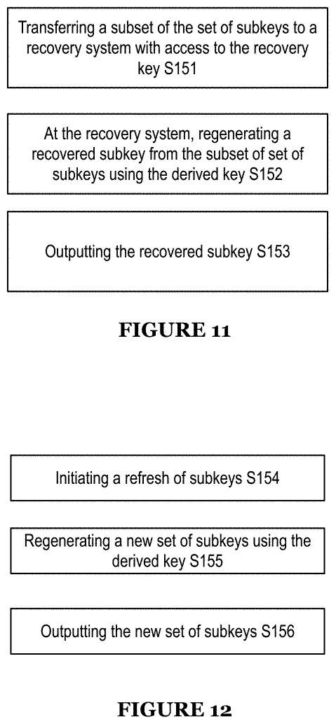

In this variation, the subkey modification involves using the recovery key in combination with at least one accessible subkey from the plurality of subkeys to determine the inaccessible or lost subkey, using the stored parity information or other derived data of the recovery key. As shown in FIG. 11, such a variation may include: transferring a subset of the set of subkeys to a recovery system with access to the recovery key S151; at the recovery system, regenerating a recovered subkey from the subset of set of subkeys using the derived key S152; and outputting the recovered subkey S153.

In some variations, the subkey-related issue indicates that the subkeys should all be refreshed—in other words, refreshing the entire set of subkeys. This may happen if a subkey is compromised and a bad actor may have access to one or more of the subkeys. Refreshing the subkeys works to update the plurality subkeys, which renders any compromised subkeys useless. Refreshing subkeys may be established at the relevant control devices (e.g., devices of difference trusted entities), and then those new subkeys can be consolidated and used in determining a new derived key. Alternatively, resulting refreshed subkeys may be redistributed to controlled devices, which could include the previous set of controlled devices but may additionally or alternatively include other controlled devices. In this variation, the subkey modification can include applying a key aggregation function to the recovery key and optionally, one or more subkeys from the plurality of subkeys to generate a new set of subkeys that maintain the combinatorial association with the primary key. As shown in FIG. 12, such a variation may include: initiating requesting a refresh of subkeys S154; regenerating a new set of subkeys using the derived key S155; and outputting the new set of subkeys S156, wherein the primary key can be reconstituted from the new set of subkeys for performing the primary key cryptographic operation.

The method may be used where it can support both processes. For example, block S150 may include the variations of S151, S152, S153, S154, S155, S156 used in combination in response to appropriate subkey issues. These processes may be initiated in response to received digital requests and/or dynamically detected events (e.g., security risk events, etc.). In this way, an implementation of the method supporting recovery and refreshing of subkeys may include: obtaining a recovery key associated with a plurality of subkeys, wherein the recovery key stores parity information or other derived data related to the plurality of subkeys; in the case of subkey recovery: a. determining a request to restore an inaccessible or lost subkey from the plurality of subkeys; combining the recovery key with another accessible subkey from the plurality of subkeys to determine the inaccessible or lost subkey using the stored parity information or other derived data; restoring the inaccessible or lost subkey (e.g., sharing with a controlling device); in the case of refreshing the subkeys: a. applying a key aggregation function possibly in combination with the recovery key and optionally, one or more subkeys from the plurality of subkeys; b. generating a new set of subkeys based on the output of the key aggregation function, wherein the new set of subkeys maintains the combinatorial association with the primary key; and redistributing to the controlling devices (or a new set of controlling devices). The old or previous subkeys may be deleted to prevent their future use with a compromised subkey.

Block S110, which includes applying a key aggregation function to create a combinatorial association between a primary key and a plurality of subkeys, functions to determine a set of subkeys (two or more subkeys) that have a particular relationship to a primary key.

A combinatorial association characterizes a relationship between the primary key and the set of subkeys where the subkeys in combination may be used to output the primary key. In other words, the combinatorial association allows for the determination of the primary key from the plurality of subkeys. Each subkey of the plurality of subkeys may be capable of being combined with one or more other subkeys of the plurality of subkeys to reconstruct the primary key. Additionally, the primary key cannot be reconstructed from any individual subkey of the plurality of subkeys. In some variations, a full set of subkeys (e.g., all the subkeys no including duplicates) may be required to reconstitute the primary key. In some variations, a subset of the set of subkeys may be required. In some variations, the subkeys may be used as input to an aggregation function to determine a primary key and/or a recovery key. Alternatively, subkeys may also be derived from a primary key.

The key aggregation function may include a variety of functions, processes, or set of processes to establish a combinatorial association between a primary key and a plurality of subkeys. The key aggregation function is preferably an operator or set of operations that establishes the combinatorial association.

The key aggregation function could be an operator or function configured to perform one or more operations across the subkeys and/or primary key such as an adding operator, subtracting, multiplying, dividing, bitwise operator (XOR, XNOR, OR, NOR, AND, NAND, and the like), and/or other operations. The operator could additionally include a combination of processes.

In some variations, subkeys may be set independent from a target primary key, and then a resulting primary key from processing the subkeys with the key aggregation function can be used as the private key. In such a variation, the method may include initially determining a set of subkeys; and then applying a key aggregation function to the set of subkeys to determine a primary key. This primary key would likely then be set and used as part of the cryptographic credentials in a digital system. Accordingly, some method variations include independently generating the subkeys on distributed control devices, from which a primary key holder (e.g., a primary control device) can aggregate the subkeys for determination of one or multiple recovery keys and derived keys. This may be used in enabling distributed reconstruction of the primary key from the set of subkeys and derived keys.

One or more user subkeys can be selected and/or randomly generated. Randomly generated user subkeys may be generated using a pseudorandom (PRNG) or true-random number generator (TRNG). In other variations, a hash (e.g., SHA-3) of an input vector or string of characters determined by a key or subkey may be another alternative. Other subkey selection processes may alternatively be used. In some such alternative variations, a user may supply a subkey. As such, block Silo may include setting at least one subkey based on input from a user which functions to collect subkey input.

As described in connection to block S130, the subkeys may be established or generated at a control device and then consolidated to a centralized device for determining the primary key.

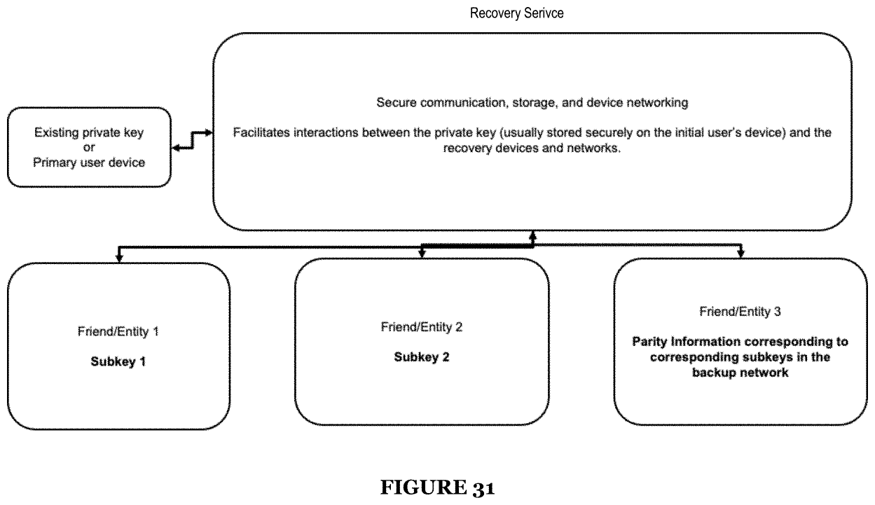

Additionally or alternatively, an externally defined end user key (e.g., like a private key) may be also supplied as input. An end user key could be used as one of the subkeys in the set of subkeys or as an addition to the set of subkeys. This may be used when a user wishes to enable their end user key to be recoverable from other subkeys. As shown in the example of FIG. 31, a recovery service may be used so that an existing private key on some primary user's device could be setup with 2 friends/entities that each have a subkey. If access to a private key is lost, then the primary user could request their friends to supply their subkeys so that the private key could be regenerated.

In some variations, applying a key aggregation function to create a combinatorial association between a primary key and a plurality of subkeys comprises: determining a set of subkeys based on a primary key. This variation may function to generate a set of subkeys given a primary key. This may be useful where a primary key is determined by an outside system. For example, a computing platform may generate a private/public key pair to use their API. The user could enter the private key into an interface to facilitate generation and setup of the subkeys. Accordingly, the method may include initially determining a primary key; and then applying the key aggregation function to create the combinatorial association between the primary key and the plurality of subkeys which includes: applying the aggregation function with input of the primary key and thereby determining the plurality of subkeys. In this variation, the subkeys may be assigned to or otherwise distributed to a control device through block S130.

In some variations, one or more of the subkeys may be defined by one or more user. This may enable a user to set a subkey such that it is more memorable or easier to use. In some instances, the primary key may be set externally, at least one user can select a subkey, and then from the primary key and the selected subkey, the remaining set of subkeys is determined. Accordingly, in such a variation, the method may include initially determining the primary key; receiving user input defining a first subkey; and applying the key aggregation function to create the combinatorial association between the primary key and the plurality of subkeys which includes: applying the aggregation function with input of the primary key and the first subkey and thereby determining the plurality of subkeys, which includes the first subkey.

Block S120, which includes determining a recovery key based on the set of subkeys, functions to establish an association between the recovery key and the subkeys and/or primary key. The recovery key (or “derived key”) can be used to resolve the lack of a subkey. The recovery key is preferably capable of regenerating at least one subkey provided another subkey from the set of subkeys. This may be used to regenerate a missing subkey given the remaining subkeys. This may also mean that the primary key can be generated given the recovery key and a subset of the subkey (e.g., if only one of two subkeys is provided). The recovery key may be a digital data record of parity information that can be used to recover all or parts of the user key. The recovery key may be maintained as a single key but may additionally be decomposed into subkeys (recovery subkeys or derived subkeys) as discussed herein.

In some variations, the subkeys are consolidated at some aggregating system, which is a trusted computing environment. In the case of a recovery example, this may be a controlled device of a primary key holder. The recovery key could be determined by applying some derived key aggregation function on collected subkeys and the primary key. For example, the recovery key may be determined by XORing the subkeys with the primary key to derive the recovery key. In some examples, the subkeys may be directed to a secured computing environment that can perform actions based on the consensus of the group.

Block S130, which includes establishing the set of subkeys at a plurality of control devices, functions instantiate the set of subkeys within different control devices. Block S130 may more generally include establishing the set of subkeys and/or the recovery key (or a set of recovery subkeys) to a plurality of control devices. Control devices (or “computing systems”) may include various computing environments, devices, or networks.

The control devices may include one or more user devices (e.g., user phones, wearable computers, laptops or desktop computers), hardware devices (e.g., digital wallet devices, security key devices, etc.), cloud platforms (e.g., data synchronizing systems), computing platforms (e.g., third party digital systems such as a digital financial account platform), blockchain networks, and/or other control devices. Accordingly, establishing the set of subkeys at a plurality of control devices may include: establishing the subkeys at the plurality of control devices selected from a set of user devices, blockchain network, and managed computing platform of a trusted entity. These different control devices may be controlled by one or more users or entities. In some variations, these control variations may generate their associated subkey and communicate that to a coordinating computing system. In other variations, subkeys may be determined and then distributed to one or more control devices.

In a variation where subkeys originate from the control device, a subkey or some other corresponding key (e.g., the recovery key) may be created within a control device. The subkey may then be selectively communicated out in isolated and secure ways. For example, during block Silo, different control device may each create their own subkey, then communicate the subkey to some computing service in order to determine a primary key and/or a recovery key. The subkeys may be communicated in encrypted form when communicating the subkey (e.g., part of aggregating subkeys from the control devices).

In another variation, establishing the set of subkeys at the plurality of control device may include distributing the set of subkeys to the plurality of control devices. How the subkeys are distributed may depend on the desired operation requirements and features of the use case.

In some variations, one or more of the subkeys and/or the recovery key may be distributed to and/or controlled by a particular entity. In one variation, one of a set of subkeys may be controlled by a trusted partner computing platform. Distributing of the subkeys may be used when one or more subkey is determined based on another subkey, primary key, and/or recovery key. After being determined it can be shared or communicated to an intended control device.

In one exemplary variation, the recovery key may be stored in a managed computing platform. The computing platform may be a trusted entity such as some third-party entity. Use of the recovery key and operations with the subkey facilitated by a recovery key may be gated and controlled according to various account authentication processes. For example, if two subkeys were generated and distributed to two different user accounts. They subkeys may be distributed through the managed computing platform. Additionally, if recovering a missing subkey of a first account, then the managed computing platform may require the accessible subkey be submitted by the second account, and when successfully completed, the recovered missing subkey can be redistributed back to the first account. Both the first account and second account may complete one or more layers of authentication.

Accordingly, in such a variation, establishing the set of subkeys to a plurality of control devices comprises: establishing the subkeys at a plurality of distinct user devices which are associated with distinct user accounts of a managed computing platform (e.g., “a recovery system or subkey management platform”). The managed computing platform may be a digital computing platform with access to the recovery key.

The recovery key could be stored in an encrypted or decrypted manner. Additionally, the recovery key may be decomposed into recovery subkeys.

In some variations, the recovery key may be stored or maintained within a blockchain network or other suitable type of distributed ledger.

Block S140, which includes reconstituting the primary key and performing primary key cryptographic operations based on receipt of a qualifying combination the set of subkeys and the recovery key, functions generate or output a primary key. The set of subkeys are preferably received from associated controlled devices. However, in some variations, the subkeys and/or the recovery key may originate from any suitable device or source. The primary key is preferably determined using some combination of subkeys and optionally the recovery key. The primary key may then be used for some use, which may involve a cryptographic operation such as digitally signing, encoding, decoding, supplying as credentials, and the like. The primary key optionally be discarded, or deleted after use, though it could be stored.

In order to perform a cryptographic operation, first, the primary key is reconstituted or determined by collecting some qualifying combination of subkeys and/or the recovery key. In some variations and/or instances, the qualifying combination of subkeys and/or the recovery key may be a qualifying combination of subkeys.

In one variation or instance, a qualifying set of subkeys is collected and then, using or based on the key aggregation function, determining the primary key. Accordingly, block S14o can include collecting the set of subkeys and determining the primary key from the set of subkeys. In another variation, block S140 may include collecting the set of subkeys and determining the primary key from the set of subkeys and derived key.

The subkeys may be collected through participation of the plurality of control devices. When different user accounts are recipients of subkeys, then they may be required to submit their subkeys through some digital system. The digital system may facilitate coordinating the collection of the set of subkeys.

The subkeys may be required to be collected within some time window (e.g., five minutes) to be used to reconstitute a primary key.

Receiving of one subkey associated with a first account may trigger a digital communication to other accounts associated with the other subkeys. For example, a group of three users may each have one subkey delivered to their account or device. If one user enters a subkey as part of a cryptographic process (authentication request, data decryption request, etc.), then the two other users may receive a digital communication notifying them of the subkey submission and enabling them to enter their subkey to enable a primary key to be generated to facilitate the cryptographic process.

When subkeys are distributed to different devices or digital services, then access to those subkeys may be triggered or facilitated in response to one or more subkeys being supplied. For example, a user may enter a user-defined subkey, this may initiate a user interface request to enter a subkey stored as part of a secure hardware device (which may or may not be controlled by the user). Some variations may additionally or alternatively have a trusted partner managing another subkey (or a partner key). Access of the subkey from a digital system of the trusted partner may similarly be initiated in response to one or more subkeys being supplied.

The qualifying combination of subkeys may be the full set of subkeys. In this variation, every subkey (i.e., non-redundant subkey in the set of subkeys) may be required to accurately reconstituted the primary key). In some variations the qualifying combination of subkeys may a qualifying subset of subkeys from the set of subkeys. In some variations, the subkeys may be determined such that not all subkeys are required. Some subkeys may hold more or less weight (e.g., one subkey held by a user may in actuality be the combination of two subkeys) or some threshold number of subkeys may be required to reconstitute a primary key and/or recover another subkey.

In some variations, the recovery key may be supplied in place of one or more subkeys. In this way, a subset of the set of subkeys and the recovery key may be supplied and used as a qualifying combination of keys to reconstitute the primary key.

When a primary key is reconstituted, it is preferably used directly for facilitating a cryptographic operation. In some variations, the primary key is deleted immediately after use or otherwise prevented from being persisted within the computing environment. In some variations, however, the primary key may be reconstituted and then stored.

Block S150, which includes utilizing the recovery key to perform subkey modification in order to address a subkey-related issue, functions to leverage the recoverability and adaptability of the subkeys afforded to it by the recovery key. The subkey modifications may be used to address both security risks and usability issues. As a usability issue, if a subkey is inaccessible (e.g., a subkey was forgotten, lost, or can't be accessed for any reason), then the other subkeys in combination with the recovery key may be used to regenerate the subkey. This means the primary key is resilient to the loss of a subkey. As a security issue, the subkeys may be refreshed or reestablished, if one or more of the subkeys is compromised. If an attacker gains access to one of the subkeys. Then the method can use the recovery key to create a new set of subkeys, that can also be used to reconstitute the primary key. The old subkeys can be destroyed. The attacker's stolen subkey can be rendered useless for determining the primary key without the old subkeys.

In one variation, a recovery process may be used for recovery of an individual subkey (e.g., which was misplaced or became inaccessible).

Recovering or regenerating a subkey, block S150 (or the method more generally) may include transferring a subset of the set of subkeys to a recovery system with access to the recovery key S151; at the recovery system, regenerating a recovered subkey from the subset of set of subkeys using the recovery key S152; and outputting the recovered subkey S153. The recovery system can be a digital system and may store the recovery key or be able to access or construct the recovery key.

Once recovered, a subkey may then be redistributed or used in various ways.

In one variation, the subkey is regenerated and returned as the output of the recovery system. The subkey can then be self-distributed to an appropriate controlled device or entity system.

In another variation, the subkey generated by the recovery system is communicated to a user account and/or controlled device associated with the subkey. For example, if a second user loses their subkey, then they must request the first user to initiate a recovery process. The second user can receive a notification within their account providing access to the recovered subkey. In the event that the user account or controlled device is compromised, then the recovered subkey may be delivered to a backup controlled device or handled in any suitable manner.

In some variations, the recovered subkey may be used directly. For example, constituting the primary key and performing primary key cryptographic operations based on receipt, from the control devices, of a qualifying combination of the set of subkeys and the recovery key may include reconstituting the primary key from the recovery key and a subset of the set of subkeys and then performing primary key cryptographic operations using the primary key.

Use of the recovery key may be restricted or otherwise secured by supplementary processes. In one variation, the recovery system can manage a data system to store the relationships of various user accounts and recovery keys. This may be used so that users may need to authenticate (using a different authentication process) as an account, and then that account must have permission to update a missing subkey.

Accordingly, block S151 (transferring the subset of subkeys), may include receiving at least one subkey in connection with authenticating a first account, and then permitting regeneration of the subkey if the first account is associated with the recovery key (in a data system of the recovery system). Permitting regeneration functions to enable the use of the recovery key. If the accounts don't match or authentication is not successful, then the regenerating the recovered subkey may be prevented.

The recovery system can be a cloud management system storing the recovery key. The recovery key is preferably stored in a data system in association with a set of accounts that are associated with the controlled devices.

Authenticating for use of the recovery key may additionally include additional authentication or authorization processes to be completed.

In one variation, use of the recovery key may require authentication by all associated accounts (or some satisfying number of accounts). For example, a majority or super majority like two out of three or four out of five subkey accounts may have to login and approve recovering a subkey.

As an additional or alternative variation, use of the recovery key may require biometric verification, knowledge challenge verification, credential challenges, device challenges (e.g., two-factor authentication, token authentication, etc.). In some variations authorization by another party may be required.

In some variations, the derived key may be decomposed into multiple derived subkeys, and the method may include collecting derived subkeys and generating the recovery key.

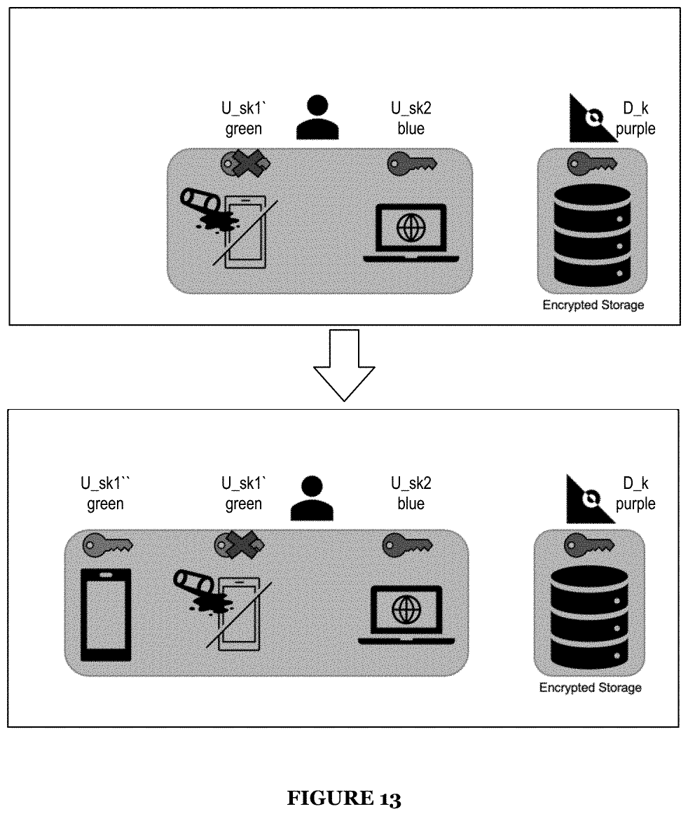

As shown in FIG. 13, the method may be implemented to address loss of a subkey. This functions to make the system more usable since if a user loses one device, they don't lose all access to their primary key (e.g., a digital wallet). As shown in FIG. 13, if one of the user key fragments is lost, the other can be used to recreate the lost key without moving funds of a wallet to a new account.

If one of the user key fragments is lost, the other can be used to recreate the lost key without moving the funds to a new account. The Derived key (D_k) can be used in combination with the currently possessed subkey (U_sk2) to regenerate the missing user subkey (U_sk1).

In another variation, utilizing the recovery key to perform subkey modification as part of some recovery or resolution process may be used for refreshing all subkeys. In such a variation, symmetrical/corresponding transformations of a set of subkeys may be performed to form updated subkeys. This change of subkeys can be performed without changing the underlying primary key (e.g., user's private key). Additionally, an updated recovery key for the updated subkeys could also be regenerated. This refresh may be performed when a subkey may have been compromised. For example, if a user realizes one of the subkeys was or could have been compromised, then the subkeys could be refreshed rendering a compromised subkey useless. This subkey may be performed without altering the user key (e.g., the primary key). It can be performed when a user suspects a subkey was compromised. Subkey refreshing may additionally or alternatively be performed as a periodic routine.

In this variation, the subkey modification can include applying a key aggregation function to the recovery key and optionally, one or more subkeys from the plurality of subkeys to generate a new set of subkeys that maintain the combinatorial association with the primary key. As shown in FIG. 12, such a variation may include: initiating a refresh of subkeys S154; regenerating a new set of subkeys using the derived key S155; and outputting the new set of subkeys S156, wherein the primary key can be reconstituted from the new set of subkeys for performing the primary key cryptographic operation.

In one variation, initiating the refresh of subkeys S154 is initiated in response to a received user request. One or more users may supply subkeys and request the subkeys be refreshed. This may be performed through a recovery system or any suitable computing environment with access to the recovery key.

In another variation, initiating the refresh of subkeys S154 may be initiated in a detected event. The method may include monitoring for security events. Detecting a subkey compromise risk (using various digital security monitoring techniques) may be used to automatically trigger a refresh of subkeys. For example, if a subkey or account is a victim of some large data hack, then all subkeys can be refreshed.

In another variation, initiating the refresh of subkeys S154 may be initiated based on routine conditions. The conditions could be a periodic time window, the usage count or frequency of usage of the subkeys.

Refreshing the set of subkeys may also trigger redistributing the new set of subkeys to the plurality of control devices. The new subkeys can be independently transferred to their respective devices or systems such that no individual user device has all subkeys. Alternatively, they may be distributed or communicated in any suitable manner.

The request for a refresh of subkeys may include the set of subkeys. Alternatively, the set of subkeys may be collected in connection with the request from multiple parties. The set of subkeys can be used to confirm authorization to refresh subkeys.

Regenerating the new set of subkeys can reperform by randomly selecting one or more subkeys. In some cases, one or more subkeys may be based on some external input. For example, one subkey may be based on a user-defined passphrase or ID. In this example, a user may supply a new passphrase used to determine one subkey and then a second subkey could be randomly determined and/or determined based on the derived key.

In some cases, the derived key is maintained. But the derived key may alternatively be refreshed as well.

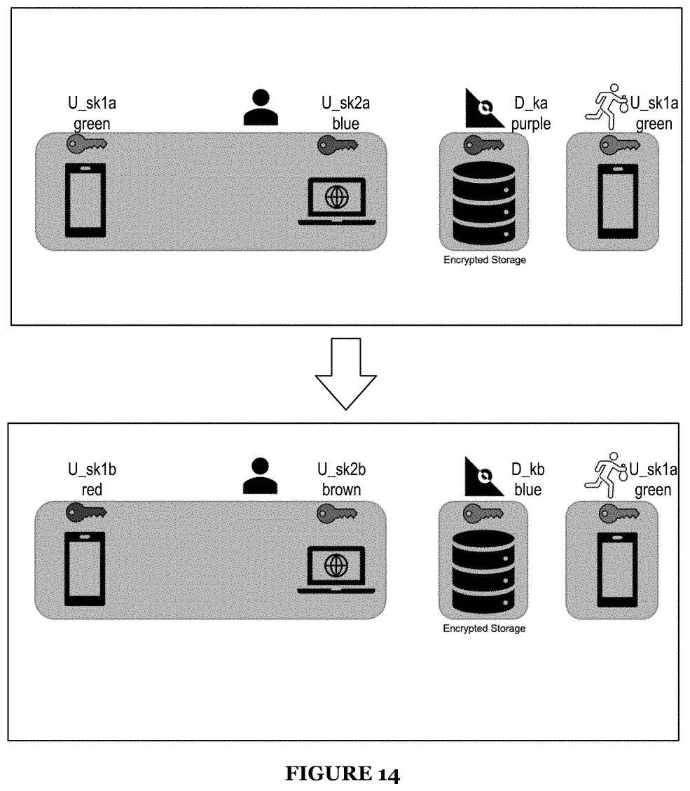

As shown in FIG. 14, the method may be used to mitigate risk to a digital wallet when a subkey is compromised. To prevent a stolen key from gaining access to the wallet, the key fragments can be changed without changing the primary key to the account. This may be done by multiplying, dividing, adding, subtracting, XOR-ing, etc. the 3 keys so they maintain a consistent result.

As shown in the detailed representative example of FIG. 1, the sub keys can be changed to have the same primary key result, and the derived key can be changed to reflect the same information to determine a subkey from one of the other subkeys.

As a related variation to recovering a subkey, the method may include performing automated security process(es). This may be used to lock an account, transfer assets, or performing other actions. Such a variation may include processing a first subkey using the recovery key and performing operations with the remaining subset of keys to perform operations to mitigate loss of assets (such as transferring cryptocurrencies to a new wallet to prevent loss).

Such subkey management methods may be used for user keys (e.g., a primary key), but may additionally be used for other involved keys such as a parity key(s) and/or a partner key(s).

The system and method may be applied and modified in different ways to prevent the primary key, or any side-channel information about such a key, from being exposed to any party including the one or multiple parties that are involved in computing the function to create the primary key.

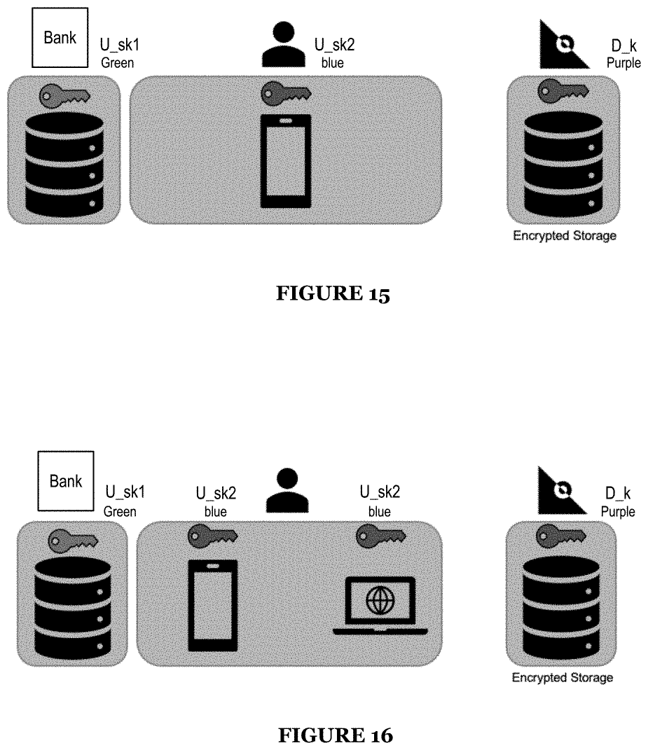

As shown in FIG. 15, one subkey could be held by an institutional partner like a bank. Where the method is used for a use case like verifying identity like a corporate or government secure ID solution, then the institutional partner may be the issuer of the ID. This is shown in FIG. 16, the user can still make copies of their key (e.g., securely stored) to increase ease of use. This redundant storage by a user could use a personal computing device, a dedicated hardware device, or even include cloud storage.

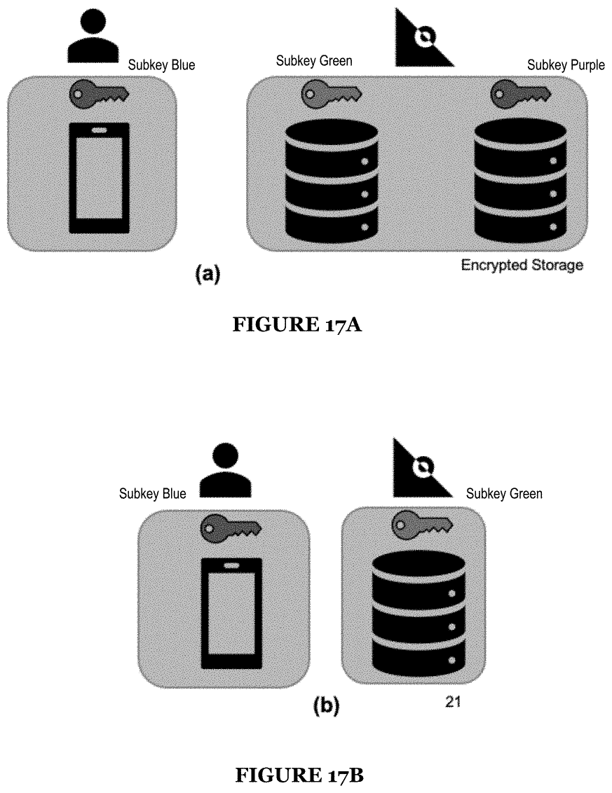

In some implementations, the method may be implemented where the user is provided with a single subkey, and a single trusted arbiter system includes the remaining subkeys. As shown in exemplary variation of FIG. 17A this may include an external managing system having one of the subkeys and a derived key. As shown in exemplary variation of FIG. 17B, the external managing system may possess a single key subkey.

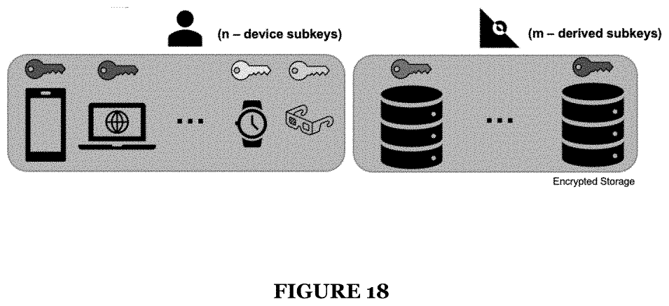

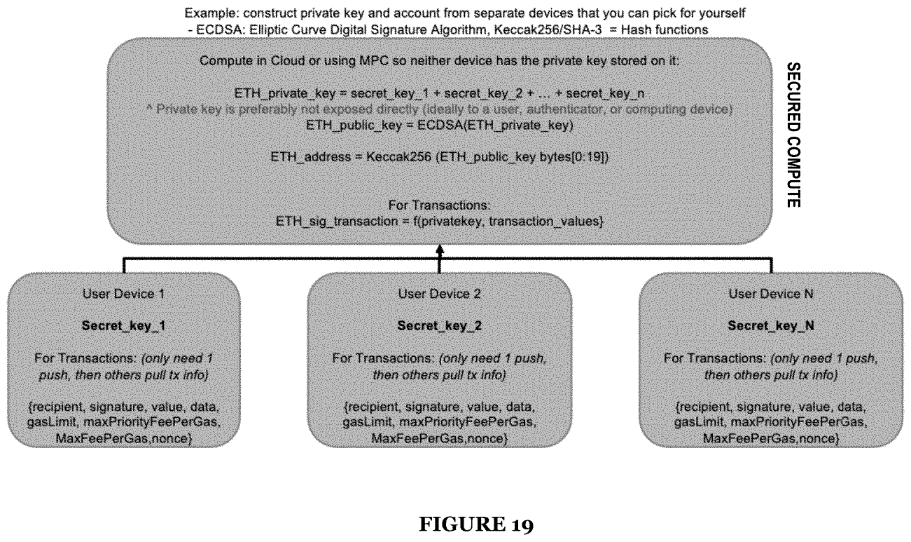

In some exemplary scenarios, the user may want to increase the total number of devices required to recreate the key. This may be used to increase security. The derived key could similarly be decomposed into an arbitrary number of subkeys as shown in FIG. 18. This should scale n devices for authentication, with m derived keys for n+m pieces of information stored. Note, operations can be used across various mathematical processes (addition, subtraction, multiplication, division, bitwise (XOR, XNOR, OR, NOR, AND, NAND, etc.).

The method may be applied to various scenarios involving a secured computation. In a set of examples shown in FIGS. 19-28, the method may be used for blockchain transactions for the various operations of master key usage, setup of a derived key, use of a derived key, and/or other operations described herein.

As shown in FIG. 19, there could be n different keys scattered across multiple devices, and those keys are independent. When combined then a primary key can be extracted for use within a secured compute operation, in this case a digital wallet transaction.

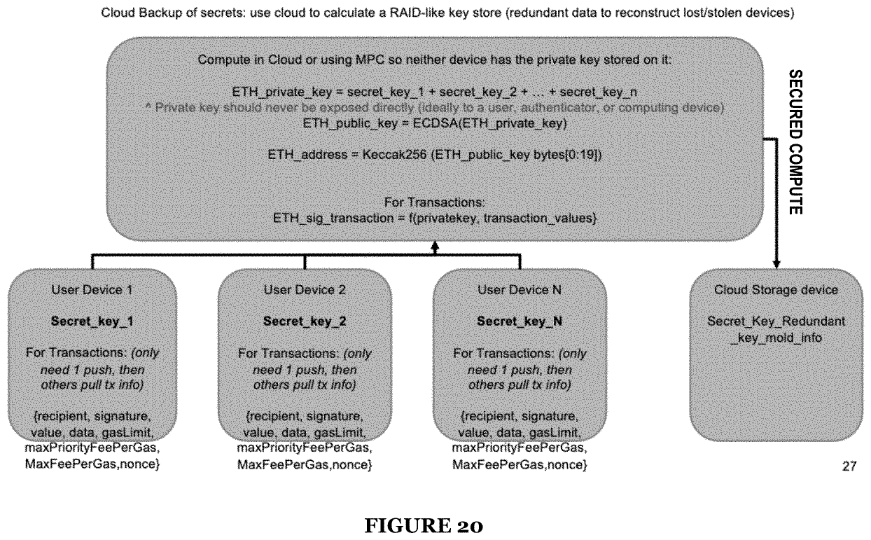

As shown in FIG. 20, for recovery purposes a cloud storage device could hold the redundant derived key so that a subkey could be recovered such that the secured compute operation may still be achievable even with the absence of one of the subkeys. The cloud storage device, however, could be prevented from taking any action without the user's cooperation. The redundant key (e.g., the derived key) could be generated and stored in the cloud service as part of a backup process while performing digital wallet transaction.

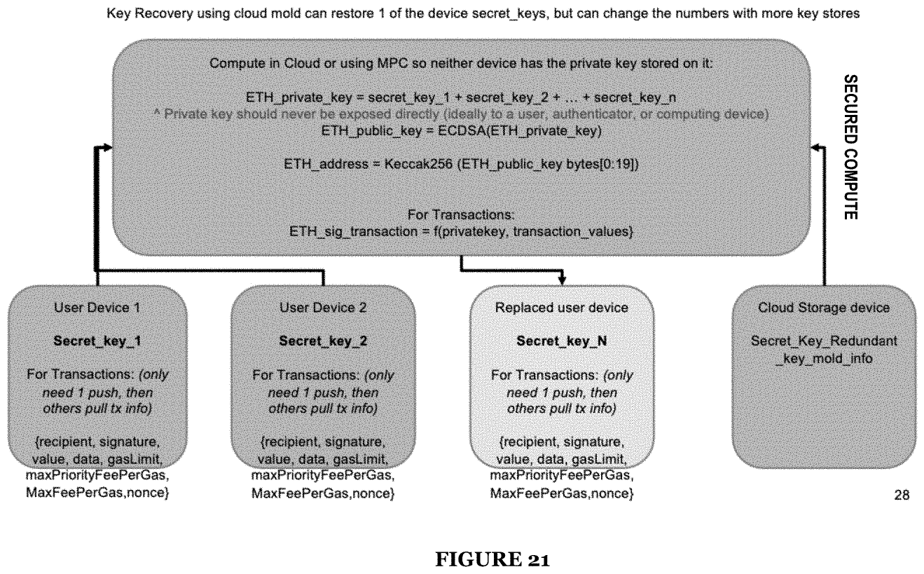

As shown in FIG. 21, in the event of a subkey being misplaced, the redundant key stored in the cloud storage could be used to regenerate the subkey.

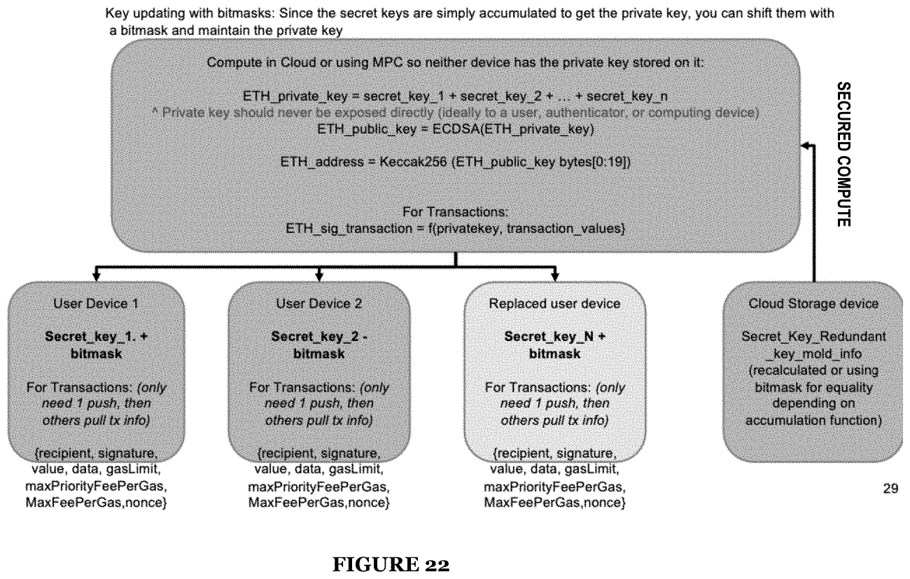

As shown in FIG. 22, the set of subkeys could all be refreshed without altering the end user key.

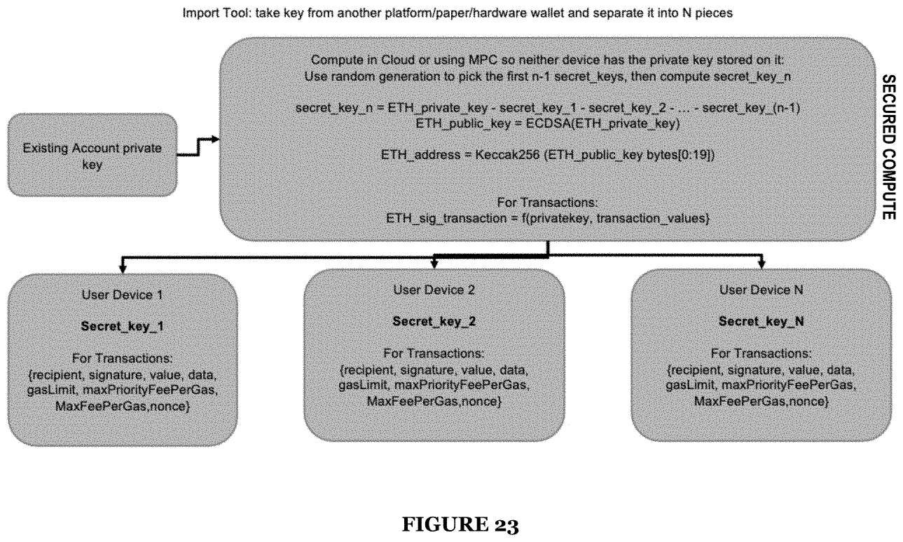

As shown in FIG. 23, the method can support the decomposition and fragmenting of an existing end user key. For example, an existing account primary key may be used initially as part of a secured compute operation, and a possible output from that process can be the generation, distribution, and/or storage of the subkeys.

The secured computation of the above examples may alternatively be modified to be a variety of secured computation operations.

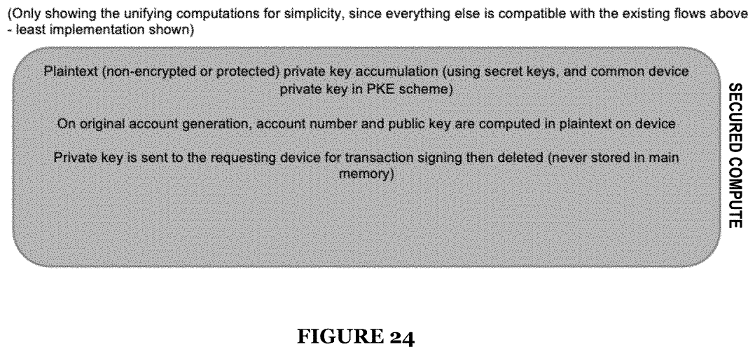

In one example shown in FIG. 24, the secured computation could be used for plaintext (non-encrypted or protected) primary key accumulation. On original account generation, account number and public key may be computed in plaintext on device, and then the primary key being sent to a requesting device for transaction. The primary key may then be deleted (and possibly never stored in main memory).

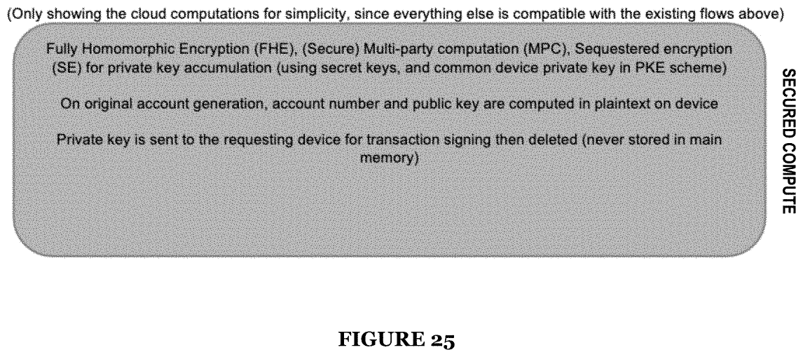

In another example shown in FIG. 25, the secured computation could be used for fully homomorphic encryption (FHE), (secure) multi-party computation (MPC), sequestered encryption (SE) for primary key accumulation. On original account generation, account number and public key may be computed in plaintext on device, and then a primary key is sent to the requesting device for transaction signing then deleted.

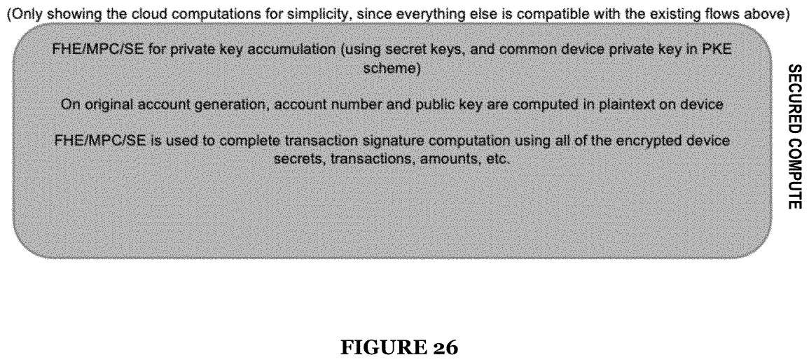

In another example shown in FIG. 26, the secured computation could be used for FHE/MPC/SE for primary key accumulation (using secret keys, and common device primary key in PKE scheme). On original account generation, account number and public key may be computed in plaintext on device, and then FHE/MPC/SE is used to complete transaction signature computation using all of the encrypted device secrets, transactions, amounts, and the like.

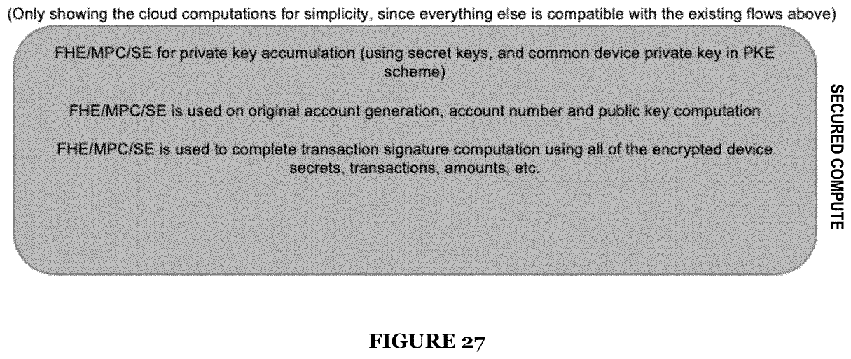

In another example shown in FIG. 27, the secured computation could be used for FHE/MPC/SE for primary key accumulation. FHE/MPC/SE may be used on original account generation, account number and public key computation, and then FHE/MPC/SE is used to complete transaction signature computation using all of the encrypted device secrets, transactions, amounts, and the like.

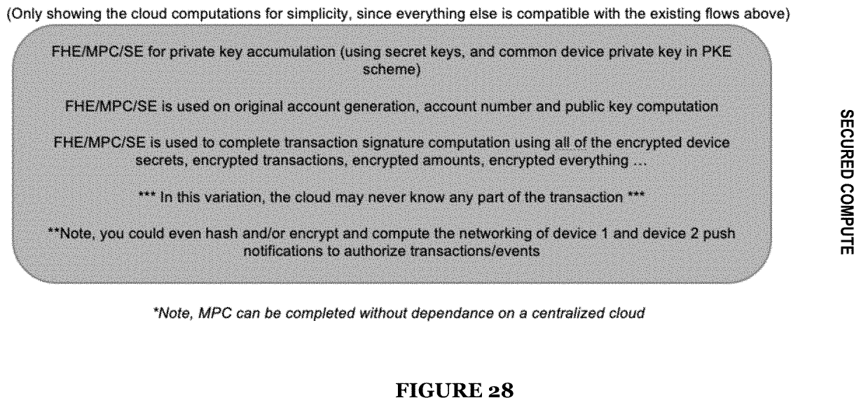

In another example shown in FIG. 28 the secured computation could be used for FHE/MPC/SE for primary key accumulation (using secret keys, and common device primary key in PKE scheme). FHE/MPC/SE is used on original account generation, account number and public key computation, and FHE/MPC/SE is used to complete transaction signature computation using all of the encrypted device secrets, encrypted transactions, encrypted amounts, and/or encrypted other components. This variation could be implemented such that the cloud never knows any part of the transaction. In this variation, a hashing, encryption, and/or computation of the networking of device 1 and device 2 push notifications to authorize transactions/events. MPC may be completed without dependence on a centralized cloud.

4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., non-transitory computer-readable mediums) storing instructions that, when executed by the one or more computer processors, cause a computing platform to perform operations comprising those of the system or method described herein such as: applying a key aggregation function to create a combinatorial association between a primary key and a plurality of subkeys, wherein the combinatorial association allows for the determination of the primary key from the plurality of subkeys; determining a recovery key based on the set of subkeys, wherein the recovery key is capable of regenerating at least one subkey provided another subkey from the set of subkeys; establishing the set of subkeys at a plurality of control devices; and reconstituting the primary key and performing primary key cryptographic operations based on receipt, from the control devices, of a qualifying combination the set of subkeys and the recovery key.

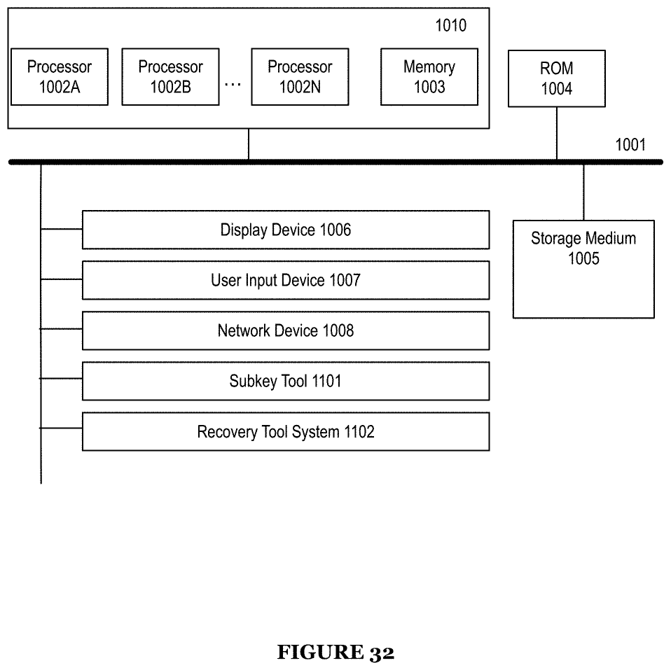

FIG. 32 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting subkey tool 1101, recovery tool system 1102, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
applying a key aggregation function to create a combinatorial association between a primary key and a plurality of subkeys, wherein the combinatorial association allows for the determination of the primary key from the plurality of subkeys;
determining a recovery key based on the set of subkeys, wherein the recovery key is capable of regenerating at least one subkey provided another subkey from the set of subkeys;
establishing the set of subkeys at a plurality of control devices; and
reconstituting the primary key and performing primary key cryptographic operations based on receipt, from the control devices, of a qualifying combination the set of subkeys and the recovery key.

2. The method of claim 1, wherein reconstituting the primary key and performing primary key cryptographic operations based on receipt, from the control devices, of a qualifying combination of the set of subkeys and the recovery key comprises: collecting the set of subkeys and determining the primary key from the set of subkeys.

3. The method of claim 1, further comprising initially determining the primary key; and wherein applying the key aggregation function to create the combinatorial association between the primary key and the plurality of subkeys comprises: applying the aggregation function with input of the primary key and thereby determining the plurality of subkeys.

4. The method of claim 1, further comprising initially determining the primary key; receiving user input defining a first subkey; and wherein applying the key aggregation function to create the combinatorial association between the primary key and the plurality of subkeys comprises: applying the aggregation function with input of the primary key and the first subkey and thereby determining the plurality of subkeys, which includes the first subkey.

5. The method of claim 1, further comprising regenerating a missing subkey comprising transferring a subset of the set of subkeys to a recovery system with access to the recovery key; at the recovery system, regenerating a recovered subkey from the subset of set of subkeys using the derived key; and outputting the recovered subkey.

6. The method of claim 5, wherein transferring a subset of the set of subkeys to a recovery system with access to the recovery key comprises receiving at least one subkey in connection with authenticating a first account, and then permitting regeneration of the subkey if the first account is associated with the recovery key.

7. The method of claim 1, further comprising: initiating a refresh of subkeys; regenerating a new set of subkeys using the derived key; and outputting the new set of subkeys, wherein the primary key is reconstituted from the new set of subkeys for performing the primary key cryptographic operation.

8. The method of claim 1, wherein establishing the set of subkeys at a plurality of control devices comprises: establishing the subkeys at a plurality of control devices selected from a set of user devices, a blockchain network, and a managed computing platform of a trusted entity.

9. The method of claim 1, wherein establishing the set of subkeys at a plurality of control devices comprises: establishing the subkeys to a plurality of distinct user devices that are associated with distinct user accounts of a recovery system, the recovery system being a digital computing platform with access to the recovery key.

10. The method of claim 1, wherein the recovery key is stored within a blockchain network.

11. The method of claim 1, wherein the recovery key is accessible within a recovery system of a computing platform.

12. The method of claim 1, wherein the key aggregation function is an operator selected from the set including: adding operator, subtracting operator, multiplying operator, dividing operator, bitwise XOR operator, bitwise XNOR operator, bitwise OR operator, bitwise NOR operator, bitwise AND operator, and a bitwise NAND operator; and wherein the recovery key stores parity information.

13. The method of claim 1, wherein reconstituting the primary key and performing primary key cryptographic operations based on receipt, from the control devices, of a qualifying combination of the set of subkeys and the derived key comprises: collecting the set of subkeys and determining the primary key from the set of subkeys and the recovery key.

14. The method of claim 1, applying a key aggregation function to create a combinatorial association between a primary key and a plurality of subkeys and establishing the set of subkeys at a plurality of control devices comprises: independently generating the set of subkeys on distributed control devices, from which a primary key holder can aggregate the subkeys for determination of one or multiple recovery keys and derived keys; and wherein reconstituting the primary key and performing primary key cryptographic operations based on receipt, from the control devices, of a qualifying combination the set of subkeys and the recovery key comprises performing distributed reconstruction of the primary key from the set of subkeys and derived keys.

15. A non-transitory computer-readable medium storing instructions that, when executed by one or more computer processors of a computing platform, cause the computing platform to perform operations comprising:
applying a key aggregation function to create a combinatorial association between a primary key and a plurality of subkeys, wherein the combinatorial association allows for the determination of the primary key from the plurality of subkeys;
determining a recovery key based on the set of subkeys, wherein the recovery key is capable of regenerating at least one subkey provided another subkey from the set of subkeys;
establishing the set of subkeys at a plurality of control devices; and
reconstituting the primary key and performing primary key cryptographic operations based on receipt, from the control devices, of a qualifying combination the set of subkeys and the recovery key.

16. The non-transitory computer-readable medium of claim 15, wherein reconstituting the primary key and performing primary key cryptographic operations based on receipt, from the control devices, of a qualifying combination of the set of subkeys and the recovery key comprises: collecting the set of subkeys and determining the primary key from the set of subkeys.

17. The non-transitory computer-readable medium of claim 15, further comprising regenerating a missing subkey comprising transferring a subset of the set of subkeys to a recovery system with access to the recovery key; at the recovery system, regenerating a recovered subkey from the subset of set of subkeys using the derived key; and outputting the recovered subkey.

18. The non-transitory computer-readable medium of claim 15, further comprising: initiating a refresh of subkeys; regenerating a new set of subkeys using the derived key; and outputting the new set of subkeys, wherein the primary key is reconstituted from the new set of subkeys for performing the primary key cryptographic operation.

19. A system comprising of:
one or more computer-readable mediums storing instructions that, when executed by the one or more computer processors, cause a computing platform to perform operations comprising:
applying a key aggregation function to create a combinatorial association between a primary key and a plurality of subkeys, wherein the combinatorial association allows for the determination of the primary key from the plurality of subkeys;
determining a recovery key based on the set of subkeys, wherein the recovery key is capable of regenerating at least one subkey provided another subkey from the set of subkeys;
establishing the set of subkeys at a plurality of control devices; and
reconstituting the primary key and performing primary key cryptographic operations based on receipt, from the control devices, of a qualifying combination the set of subkeys and the recovery key.

20. The system of claim 19, wherein reconstituting the primary key and performing primary key cryptographic operations based on receipt, from the control devices, of a qualifying combination of the set of subkeys and the recovery key comprises: collecting the set of subkeys and determining the primary key from the set of subkeys.

21. The system of claim 19, further comprising regenerating a missing subkey comprising transferring a subset of the set of subkeys to a recovery system with access to the recovery key; at the recovery system, regenerating a recovered subkey from the subset of set of subkeys using the derived key; and outputting the recovered subkey.

22. The system of claim 19, further comprising: initiating a refresh of subkeys; regenerating a new set of subkeys using the derived key; and outputting the new set of subkeys, wherein the primary key is reconstituted from the new set of subkeys for performing the primary key cryptographic operation.
